(19) United States
(12) Patent Application Publication
(10) Pub. No.: US 2026/0019873 A1
(43) Pub. Date: Jan. 15, 2026

(54) Network Architecture and Stateless Design for a Cellular Network

(71) Applicant: Apple Inc., Cupertino, CA (US)

(72) Inventors: Peng CHENG, Beijing (CN); Alexander SIROTKIN, Hod Hasharon (IL); Behrouz AGHILI, Poway, CA (US); Fangli Xu, Beijing (CN); Haijing HU, Los Gatos, CA (US); Naveen Kumar R PALLE VENKATA, San Diego, CA (US); Ping-Heng KUO, London (GB); Ralf ROSSBACH, Munich (DE); Sudeep MANITHARA VAMANAN, Uttenreuth (DE); Yuqin CHEN, Beijing (CN); Zhibin WU, Los Altos, CA (US)

(21) Appl. No.: 18/875,902

(22) PCT Filed: Jun. 28, 2022
(86) PCT No.: PCT/CN2022/102035

§ 371 Date: Dec. 17, 2024

(51) Int. Cl. H04W 28/08; H04W 36/00

(52) U.S. Cl. CPC H04W 28/0846; H04W 36/0033

(57) ABSTRACT

A network function of a core network configured to store a plurality of contexts for a user equipment (UE) and perform an operation with another network function associated with a procedure related to the UE being performed by the core network, wherein the operation is related to at least one of the plurality of contexts.

### TECHNICAL FIELD

The present disclosure generally relates to wireless communication, and in particular, to network architecture and stateless design for a cellular network.

### BACKGROUND

Evolutions of cellular networks will encompass new use cases, emerging technologies and trends that will impact overall network architecture and user equipment (UE) interactions. The network architecture needs to evolve to support an integrated network across air, ground, and space providing ubiquitous communication services while being cognizant of industry trends in network disaggregation and intelligence, which opens up the possibility of an artificial intelligence (AI) native end-to-end (E2E) intelligent network.

The boundaries between the radio access network (RAN) and the core network (CN) traditionally determined based on where specific functionality and contextual information was hosted, need to be re-examined in light of other emerging requirements and capabilities such as computing, perception, intelligence, co-ordination and security which extend E2E.

### SUMMARY

Some exemplary embodiments are related to a network function of a core network configured to store a plurality of contexts for a user equipment (UE) and perform an operation with another network function associated with a procedure related to the UE being performed by the core network, wherein the operation is related to at least one of the plurality of contexts.

Other exemplary embodiments are related to a network function residing in a service based architecture (SBA) of a core network and configured to perform functions related to a central unit control plane of a base station of a radio access network and perform functions related to access and mobility management of a user equipment (UE).

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows a first exemplary embodiment of a service based architecture (SBA) framework for a cellular network according to various exemplary embodiments.

FIG. 5 shows a second exemplary embodiment of an SBA framework for a cellular network according to various exemplary embodiments.

FIG. 6 shows a third exemplary embodiment of an SBA framework for a cellular network according to various exemplary embodiments.

FIG. 7 shows an exemplary registration signaling diagram for a UE to register with a network according to various exemplary embodiments.

FIG. 8 shows an exemplary UE initiated deregistration signaling diagram for a UE to deregister from a network according to various exemplary embodiments.

FIG. 9 shows an exemplary capability exchange signaling diagram between a UE and a network according to various exemplary embodiments.

FIG. 10 shows an exemplary PDU session establishment signaling diagram according to various exemplary embodiments.

FIG. 11 shows an exemplary PDU session release signaling diagram according to various exemplary embodiments.

FIG. 12 shows an exemplary UE-initiated service request signaling diagram according to various exemplary embodiments.

FIG. 13 shows an exemplary network initiated service request signaling diagram according to various exemplary embodiments.

FIG. 14 shows an exemplary Xn based handover (HO) signaling diagram according to various exemplary embodiments.

FIG. 15 shows an exemplary N2 based HO preparation signaling diagram according to various exemplary embodiments.

FIG. 16 shows an exemplary N2 based HO execution signaling diagram according to various exemplary embodiments.

### DETAILED DESCRIPTION

The exemplary embodiments may be further understood with reference to the following description and the related appended drawings, wherein like elements are provided with the same reference numerals. The exemplary embodiments relate to an Service-Based Architecture (SBA) where a control plane of a RAN is integrated into the SBA framework of the core network. In other aspects, the exemplary embodiments relate to a network function storing a context for a UE.

The exemplary embodiments are described with reference to a Service-Based Architecture (SBA) where certain functionalities are delivered by a set of interconnected Network Functions (NFs). The SBA framework was initially introduced by the Third Generation Partnership (3GPP) in the standards for 5G, e.g., New Radio (NR) standards.

The exemplary embodiments are related to introducing additional functionality into the SBA framework, specifically functionality that currently resides in the radio access network (RAN). Some exemplary embodiments are related to integrating the control plane of the RAN (e.g., the central unit control plane (CU-CP) of the base stations) into the SBA framework of the core network (CN). Other exemplary embodiments are related to integrating the CU-CP into the SBA framework, but merging the functionality of the CU-CP and the current Access and Mobility Management Function (AMF) into a new NF termed a C-Node. The exemplary SBA frameworks comprising the above examples will be described in greater detail below.

The exemplary embodiments are also related to a stateless design where a user equipment (UE) context is stored in a new NF termed a UE Context Repository Function (UCRF). This stateless design will save latency caused by a new base station having to find the UE context in an old base station, allows some signaling to be in parallel and increases the robustness of the network, e.g., if the old base station failed, the new base station can quickly find the UE context in the separate NF. The exemplary UCRF will be described in greater detail below.

The exemplary embodiments will be described with reference to the network implementing the new SBA framework as a 5G NR network. However, it should be understood that the exemplary embodiments of the SBA framework may be implemented in further evolutions of the cellular standards, e.g., 6G networks or later.

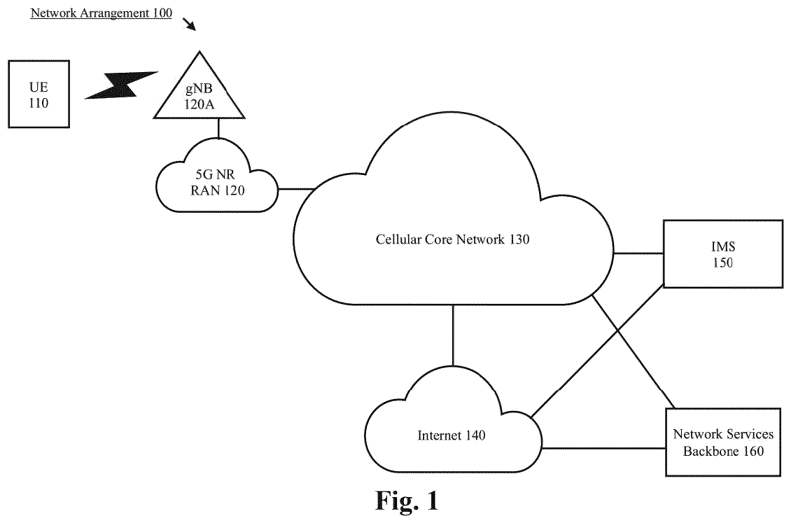

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables (e.g., head mounted display (HMD), AR glasses, etc.), Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., further evolutions of the cellular standards such as 6G networks, a 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with at least the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

In the network arrangement 100, the UE 110 may connect to the 5G NR-RAN 120 via the gNB 120A. Those skilled in the art will understand that any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific base station (e.g., gNB 120A). However, as mentioned above, reference to the 5G NR-RAN 120 is merely for illustrative purposes and any appropriate type of RAN may be used.

The network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

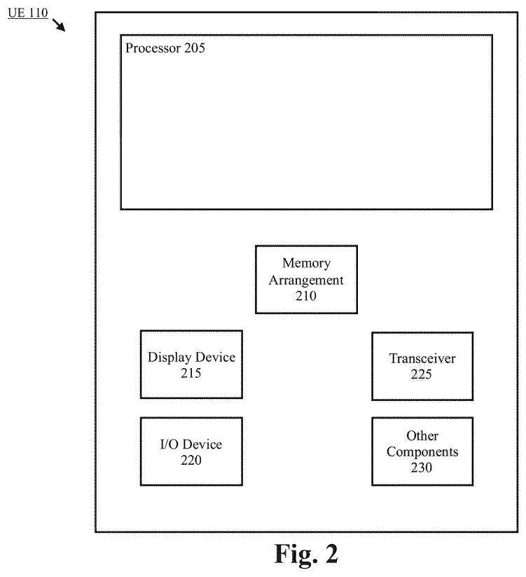

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute multiple engines of the UE 110. These engines may be used to perform various procedures between the UE 110 and the network. Examples of these procedures will be described in greater detail below.

The above referenced engines being an application (e.g., a program) executed by the processor 205 is merely provided for illustrative purposes. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120 and/or any other appropriate type of network. Accordingly, the transceiver 225 may operate on a variety of different frequencies or channels (e.g., set of consecutive frequencies).

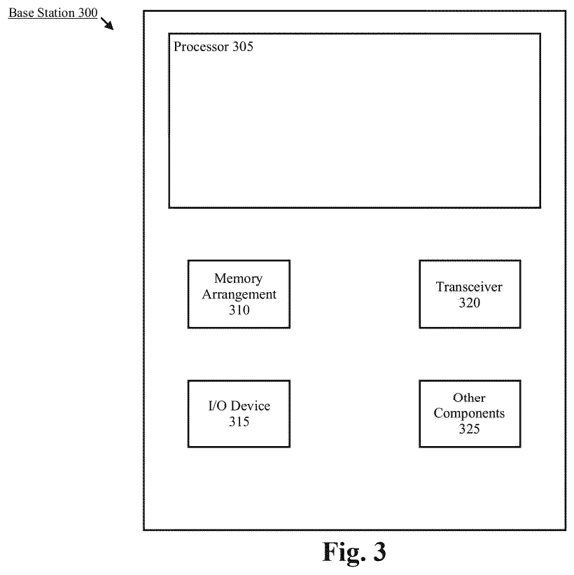

FIG. 3 shows an exemplary base station 300 according to various exemplary embodiments. The base station 300 may represent any access node (e.g., gNB 120A, etc.) through which the UE 110 may establish a connection and manage network operations.

The base station 300 may include a processor 305, a memory arrangement 310, an input/output (I/O) device 315, a transceiver 320, and other components 325. The other components 325 may include, for example, a battery, a data acquisition device, ports to electrically connect the base station 300 to other electronic devices, etc.

The processor 305 may be configured to execute a plurality of engines of the base station 300. These engines may be used to perform various procedures between the UE 110 and the base station 300 and/or the core network 130 and the base station 300. Examples of these procedures will be described in greater detail below.

The above noted engines being an application (e.g., a program) executed by the processor 305 is only exemplary. The functionality associated with the engines may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the system 100. The transceiver 320 may operate on a variety of different frequencies or channels (e.g., set of consecutive frequencies). Therefore, the transceiver 320 may include one or more components (e.g., radios) to enable the data exchange with the various networks and UEs.

The following will provide examples of the new SBA framework. It should be understood that the new SBA framework will include previous defined NFs, e.g., by the 3GPP standards. These previously defined NFs will be identified but the specific functionality of each of these previously defined NFs are not described herein. It may be considered that these previously defined NFs operate in accordance with their definition by the network standards.

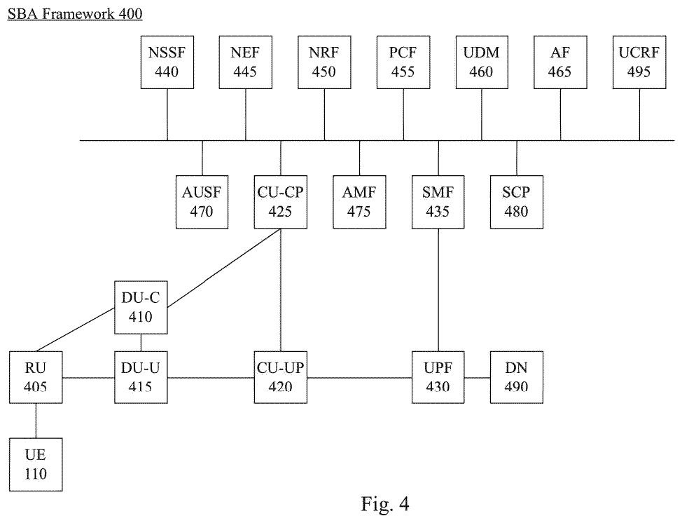

FIG. 4 shows a first exemplary embodiment of an SBA framework 400 for a cellular network according to various exemplary embodiments. Initially, it may be considered that FIG. 4 shows functional components related to the network arrangement 100, e.g., the UE 110, the 5G NR-RAN 120 and the core network 130. In addition, in the description below, it should be considered that reference to “connections” between different functions and/or components is not limited to a physical connection, e.g., over-the-air (OTA) or hardwired. The connection may include any manner of communicating between the different functions and/or components, e.g., software communications, cloud communications, etc.

The UE 110 is connected to the radio unit (RU) 405 of the gNB 120A. The gNB 120A also includes a distributed unit (DU) and a control unit (CU). In this example, the RU 405 is connected to a control plane of the DU (DU-C) 410 and a user plane of the DU (DU-U) 415. The DU-U 415 is connected to the user plane of the CU (CU-UP) 420, which has a connection to the user plane function (UPF) 425 of the core network 130. This allows a connection to a data network (DN) 490 or to other NFs of the core network 130, e.g., a session management function (SMF) 435.

As described above, some exemplary embodiments are related to integrating the control plane of the RAN (e.g., the central unit control plane (CU-CP) 425) into the SBA framework of the core network 130. This is represented in FIG. 4 by the CU-CP 425 residing with the other NFs of the core network 130. The DU-C 410 is connected to the CU-CP 425.

The remaining core networks 130 NFs comprise a network slice selection function (NSSF) 440, a network exposure function (NEF) 445, a NF repository function (NRF) 450, a policy control function (PCF) 455, a unified data management (UDM) 460 function, an application function (AF) 465, an authentication server function (AUSF) 470, an access and mobility function (AMF) 475 and a service communication proxy (SCP) 480. It should be understood that the core network 130 is not limited to these NFs and there may be additional NFs implemented by the core network 130.

FIG. 4 also shows the new UCRF 495, which as described above, is a new NF that stores a UE context. The operations of the UCRF 495 will be described in greater detail below.

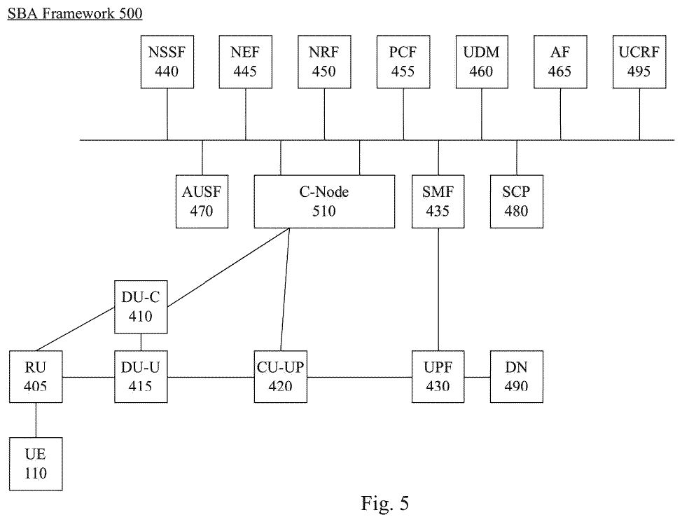

FIG. 5 shows a second exemplary embodiment of an SBA framework 500 for a cellular network according to various exemplary embodiments. The SBA framework 500 includes many of the same functions as FIG. 4 that are labelled with the same reference numerals and will not be described for a second time. In addition, the new UCRF 495 is also shown and will be discussed in greater detail below.

The difference between SBA framework 500 and SBA framework 400 is that in SBA framework 500, the functionality of the CU-CP and the AMF are merged into a C-Node 510 that is shown as a core network 130 NF. The C-Node 510 may provide various functionalities including, but not limited to, merged access stratum (AS) and non-access stratum (NAS) security control, registration, merged AS and NAS connection management, merged AS and NAS mobility management, act as a mobility anchor, access authentication and authorization, support for non-3GPP access networks, radio resource control (RRC) and configuration, etc.

The SBA framework 500 using the C-Node 510 that combines the functionality of the CU-CP and the AMF may allow additional signaling payload and latency benefits of a RAN-CN convergence that is superior to the SBA framework 400. However, it should be understood that the SBA framework 400 may still allow signaling payload and latency benefits over the prior art CU-CP residing exclusively in the RAN. One benefit of moving the CU-CP (whether individually or as part of the C-Node 510) into the NFs of the core network, is that the functions may then communicate with other core network 130 NFs using the Hypertext Transfer Protocol 2 (http/2), allowing for less latency for such communications.

Turning to the new UCRF NF, in current 5G NR networks, there are 3 different UE contexts stored in the network: 1) UE AS context is stored in the CU-CP; 2) UE registration management (RM) context can be stored in the AMF or the unstructured data storage function (UDSF); and 3) UE session management (SM) context can be stored in the SMF or the UDSF.

However, since the CU-CP is integrated into the core network 130 SBA architecture (e.g., SBA framework 400 or SBA framework 500), it is possible to introduce a full stateless design, e.g., all the above 3 UE contexts are stored in a single NF, e.g., the UCRF 495. Some of the benefits of the stateless design were described above. The stateless design simplifies many procedures between the UE and the network including, but not limited to, registration/deregistration, mobility, capability exchange, protocol data unit (PDU) session establishment/modification/release, UE or network triggered service requests, etc. Some exemplary procedures using the UCRF 495 will be described below.

As shown in FIGS. 4 and 5, in some exemplary embodiments, the UCRF 495 may be included in the SBA architecture of the core network 130. This will allow for a unified service based architecture/signaling between the core network NFs and the UCRF 495. However, if the AS context for all UEs is stored in a separate UCRF 495, the base station (e.g., gNB 120A) will fetch the AS context for each UE, which may cause load and/or latency bottlenecks.

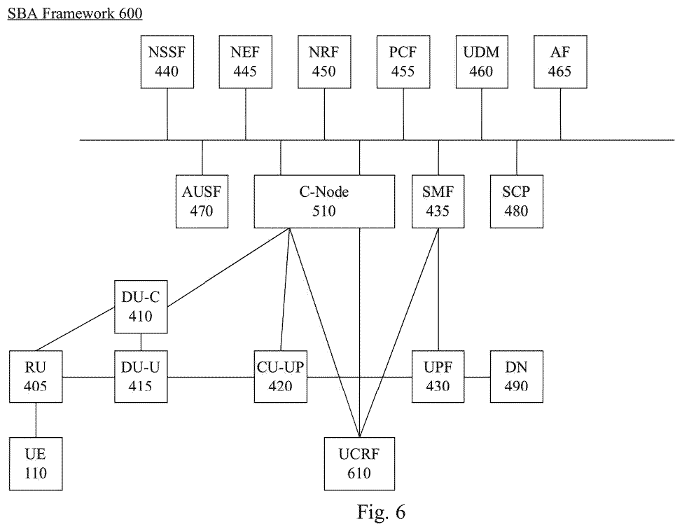

FIG. 6 shows a third exemplary embodiment of an SBA framework 600 for a cellular network according to various exemplary embodiments. The SBA framework 600 includes all the same functions as FIG. 5 that are labelled with the same reference numerals and will not be further described.

In this exemplary embodiment, the new UCRF 610 is shown as being deployed close to the gNB to store the AS context for the UE 110 to reduce the latency to fetch the AS UE context. In these exemplary embodiments, a separate interface that is similar to the interface for the UPF may be introduced. This allows the UCRF 610 to be deployed closer to the edge, e.g., co-located with other edge nodes or the RAN. It should be noted that while this exemplary embodiment is shown with reference to the SBA framework that has the C-Node, this UCRF being deployed close to the gNB may also be implemented for the SBA framework that has a separate CU-CP and AMF.

In further exemplary embodiments, a hybrid approach between the above examples (e.g., the UCRF in the core network SBA or the UCRF closer to the edge) may be used. For example, the RM UE context and the SM UE context may be stored in a UCRF in the core network SBA and the AS UE context may be stored in a separate UCRF closer to the edge. In another example, the AS UE context may be stored in a UCRF closer to the edge and the RM/SM UE context may be stored in a UDSF. From this example, it should be understood that the existing UDSF may be modified and/or extended to achieve the intention of the UCRF.

As described above, the stateless design using the UCRF may simplify many procedures between the UE and the network. The following will provide various examples of simplified procedures that may reduce latency and signaling. Those skilled in the art will understand the signaling used for the current procedures and thus, these current legacy procedures will not be described herein, except that in some cases, operations or signaling that are no longer needed may be mentioned. Furthermore, when describing each of the following exemplary procedures, it may be considered that the procedures are successful, e.g., the described operations assume that the information exchange between the various components are successful.

In addition, the example procedures are described with reference to the SBA framework that includes the C-Node that combines the functionality of the CU-CP and AMF. However, it should be understood that the exemplary procedures may also be implemented in the SBA framework that includes the separate CU-CP and AMF functions. Those skilled in the art will understand how to modify the following exemplary signaling diagrams to implement the procedures for the separate CU-CP and AMF functions.

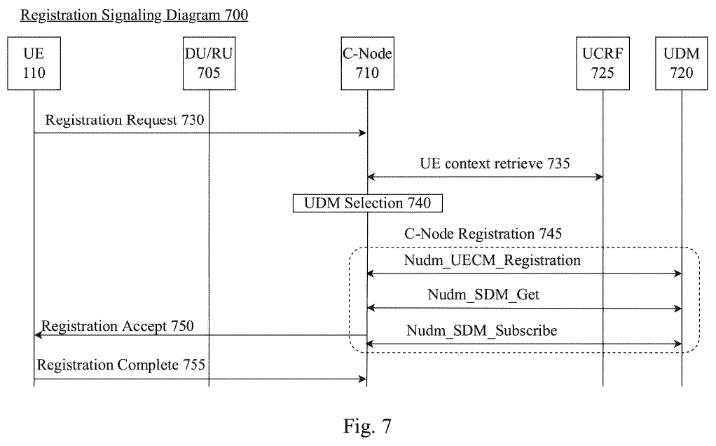

FIG. 7 shows an exemplary registration signaling diagram 700 for a UE 110 to register with a network according to various exemplary embodiments. The signaling will occur between the UE 110, the DU/RU 705 of the gNB 120A, the C-Node 710, the UCRF 715 and the UDM 720. As described above, the registration procedure is simplified because the UE 110 context is stored in the UCRF 715.

In 730, the UE 110 sends a registration request to the C-Node 710 via the DU/RU 705. In 735, the C-Node 710 retrieves the context of the UE 110 from the UCRF 715. As described above, since all the contexts for the UE 110 (including the RM context) are stored at the UCRF 710, the C-Node 710 does not need to contact any additional NFs regarding the RM context. In 740, the C-Node 710 selects the UDM for the registration procedure.

In 745, the C-Node 710 performs the registration procedure with the selected UDM 720, including the Nudm_UECM_Registration, the Nudm_SDM_Get and the Nudm_SDM_Subscribe operations. In this example, among other operations, there is no interaction between a new AMF and an old AMF as in the legacy registration procedure.

In 750, the C-Node 710 sends a registration accept message to the UE 110 and in 755, the UE 110 returns a registration complete message to the C-Node 755.

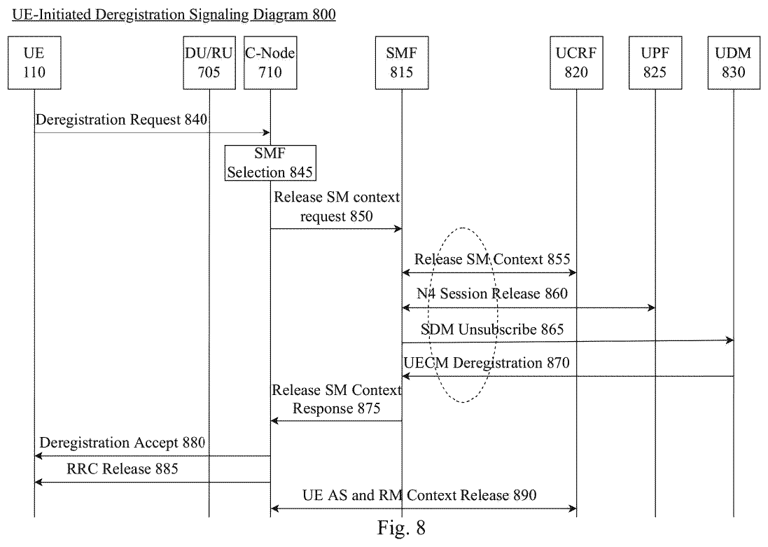

FIG. 8 shows an exemplary UE initiated deregistration signaling diagram 800 for a UE 110 to deregister from a network according to various exemplary embodiments. The signaling will occur between the UE 110, the DU/RU 805 of the gNB 120A, the C-Node 810, the SMF 815, the UCRF 820, the UPF 825 and the UDM 830.

In 840, the UE 110 sends a deregistration request to the C-Node 810 via the DU/RU 805. In 845, the C-Node 810 selects the SMF 815 currently associated with the UE 110. In 850, the C-Node 810 sends a release SM context request to the selected SMF 815.

In 855, the SMF 815 sends a release SM context message to the UCRF 820. In 860, the SMF 815 sends a N4 session release message to the UPF 825. In 865, the SMF 815 sends a subscriber data management (SDM) unsubscribe message to the UDM 830. In 870, the SMF 815 receives a UE Context Management (UECM) deregistration message from the UDM 830. As shown in FIG. 8, the operations 855-870 may run in parallel based on the JavaScript Object Notation (JSON) supported by http/2.

In 875, the SMF 815 sends a release SM context response to the C-Node 810. In 880, the C-Node 810 sends a deregistration accept message to the UE 110. In 885, the UE 110 sends a RRC release message to the C-Node 810. Finally, in 890, the C-Node 810 and the UCRF 820 exchange message(s) indicating the AS context and the RM context for the UE 110 has been released.

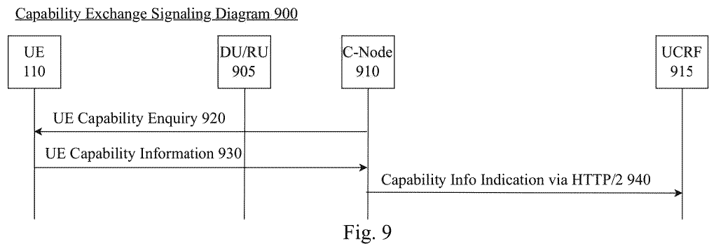

FIG. 9 shows an exemplary capability exchange signaling diagram 900 between a UE 110 and a network according to various exemplary embodiments. The signaling will occur between the UE 110, the DU/RU 905 of the gNB 120A, the C-Node 910, and the UCRF 915.

In 920, the C-Node 910 sends a UE capability enquiry to the UE 110 via the DU/RU 905. In 930, the UE 110 sends a UE capability information response including the UE 10 capability information to the C-Node 910. In 940, the C-Node 910 sends the UE 110 capability information to the UCRF 915. The UCRF 915 may store the UE 110 capability information as part of the UE context.

This capability reporting procedure negates the need to have capability related signaling in both the RRC and NAS layers. The NAS capability and AS capability may be merged. Thus, in some exemplary embodiments, only the RRC capability signaling is retained. While in other exemplary embodiments, the capability enquiry/information messaging is moved to the NAS layer so the RRC protocol no longer handles UE capability signaling.

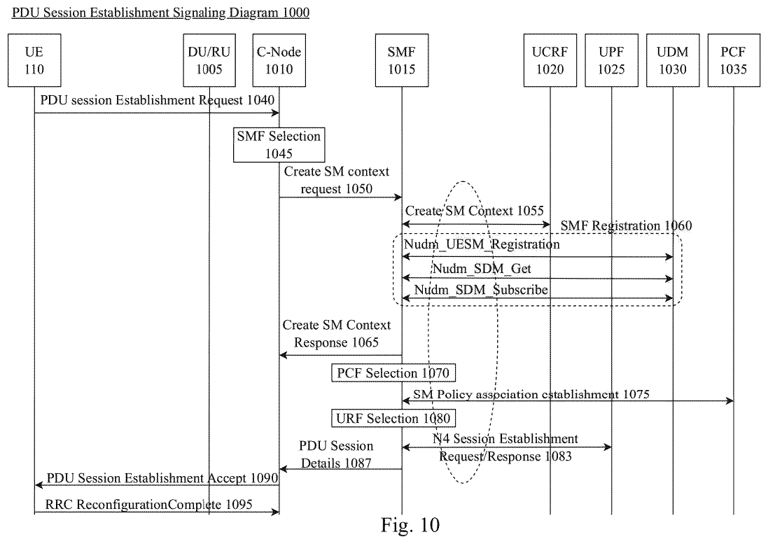

FIG. 10 shows an exemplary PDU session establishment signaling diagram 1000 according to various exemplary embodiments. The signaling will occur between the UE 110, the DU/RU 1005 of the gNB 120A, the C-Node 1010, the SMF 1015, the UCRF 1020, the UPF 1025, the UDM 1030 and the PCF 1035.

In 1040, the UE 110 sends a PDU session establishment request to the C-Node 1010 via the DU/RU 1005. In 1045, the C-Node 1010 selects the SMF 1015 currently associated with the UE 110. In 1050, the C-Node 1010 sends a create SM context request to the selected SMF 1015. In 1055, the SMF 1015 and the UCRF 1020, perform a create SM context procedure to create the SM context.

In 1060, the SMF 1015 registers with the UDM 1030, including the Nudm_UESM_Registration, the Nudm_SDM_Get and the Nudm_SDM_Subscribe operations. In 1065, the SMF 1015 sends a create SM context response to the C-Node 1010. In 1070, the SMF 1015 selects a PCF for the PDU session. In 1075, the SMF 1015 performs a SM policy association establishment procedure with the selected PCF 1035 for the PDU session. In 1080, the SMF 1015 selects a UPF for the PDU session. In 1083, the SMF 1015 performs a N4 session establishment request/response with the selected UPF 1025 for the PDU session. As shown in FIG. 10, the operations 1055-1083 may run in parallel based on the JSON supported by http/2.

In 1087, the SMF 1015 informs the C-Node 1010 of the PDU session details. In 1090, the C-Node 1010 may then send a PDU session establishment accept message to the UE 110 and the UE 110 may then, in 1095, send an RRCReconfigurationComplete message to the C-Node 1010.

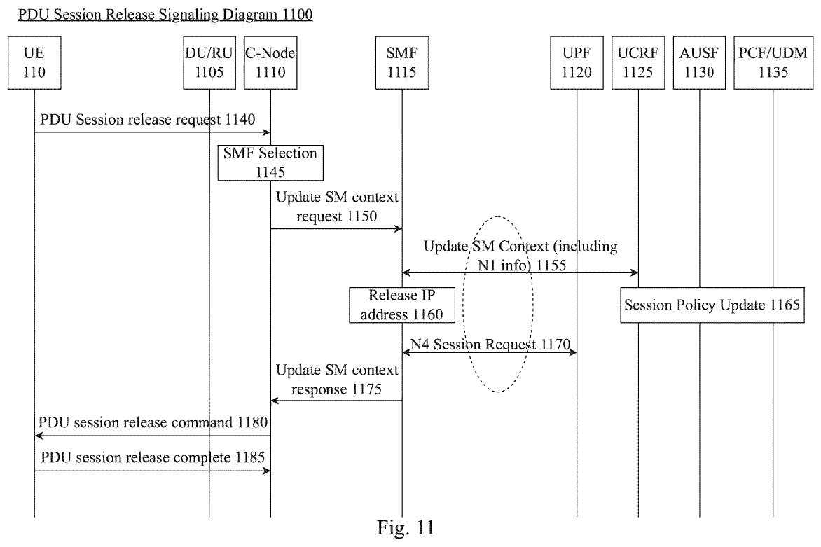

FIG. 11 shows an exemplary PDU session release signaling diagram 1100 according to various exemplary embodiments. The signaling will occur between the UE 110, the DU/RU 1105 of the gNB 120A, the C-Node 1110, the SMF 1115, the UPF 1120, the UCRF 1125, the AUSF 1130 and the PCF/UDM 1135.

In 1140, the UE 110 sends a PDU session release request to the C-Node 1110 via the DU/RU 1105. In 1145, the C-Node 1110 selects the SMF 1115 currently associated with the UE 110. In 1150, the C-Node 1110 sends an update SM context request to the selected SMF 1115.

In 1155, the SMF 1015 and the UCRF 1125, perform an update SM context procedure (including the N1 information) to update the SM context for the UE 110. In 1160, the SMF 1115 releases the IP address of the PDU session. In 1170, the SMF 1115 and the UPF 1120 perform an N4 session release procedure. As shown in FIG. 11, the operations 1155, 1160 and 1170 may run in parallel based on the JSON supported by http/2.

In 1165, a session policy update may be shared between the UCRF 1125 and the PCF/UDM 1135 based on the updated SM context. In 1175, the SMF 1115 sends an update SM context response to the C-Node 1110. The C-Node 1110 may then send, in 1180, a PDU session release command to the UE 110. The UE 110 releases the PDU session and sends a PDU session release complete message in 1185.

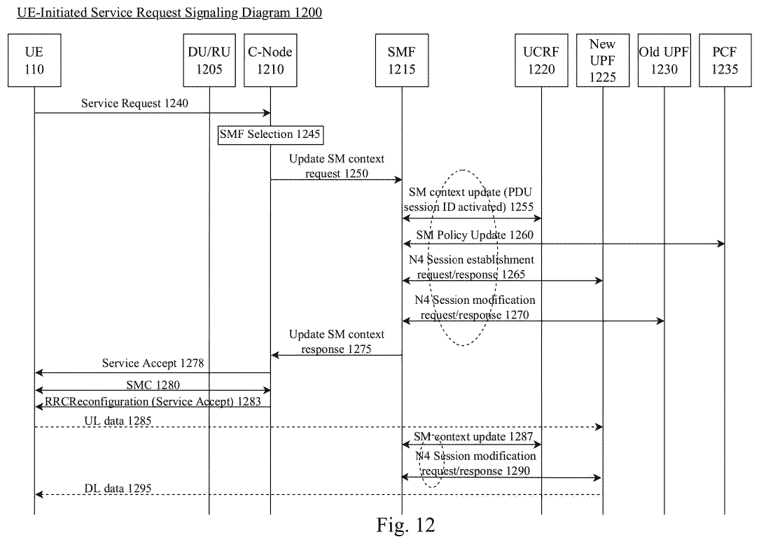

FIG. 12 shows an exemplary UE-initiated service request signaling diagram 1200 according to various exemplary embodiments. The signaling will occur between the UE 110, the DU/RU 1205 of the gNB 120A, the C-Node 1210, the SMF 1215, the UCRF 1220, the new UPF 1225, the old UPF 1230 and the PCF 1235.

In 1240, the UE 110 sends a service request to the C-Node 1210 via the DU/RU 1205. In 1245, the C-Node 1110 selects the SMF 1215 for the service. In 1250, the C-Node 1210 sends an update SM context request to the selected SMF 1215.

In 1255, the SMF 1215 performs an SM context update procedure with the UCRF 1220 including an indication that a PDU session ID has been activated. In 1260, the SMF 1215 and the PCF 1235 perform an SM policy update procedure. In 1265, the SMF 1215 and the new UPF 1225 perform an N4 establishment request/response procedure, while in 1270, the SMF 1215 and the old UPF 1230 perform an N4 modification request/response procedure. As shown in FIG. 12, the operations 1255-1270 may run in parallel based on the JSON supported by http/2.

In 1275, the SMF 1215 sends an update SM context response to the C-Node 1210. In 1278, the C-Node 1210 sends a service accept message to the UE 110. In 1280, the UE 110 and the C-Node 1210 perform a security mode command (SMC) procedure for this context. The C-Node 1210 then sends a RRC Reconfiguration message in 1283 indicating the service is accepted. In 1285, the UE 110 may send uplink (UL) data to the new UPF 1225.

In 1287, the SMF 1215 and the UCRF 1220 perform an SM context update procedure. In 1290, the SMF 1215 and the new UPF 1225 perform an N4 modification request/response procedure. As shown in FIG. 12, the operations 1287-1290 may run in parallel based on the JSON supported by http/2. In 1290, the new UPF 1225 may deliver downlink (DL) data to the UE 110.

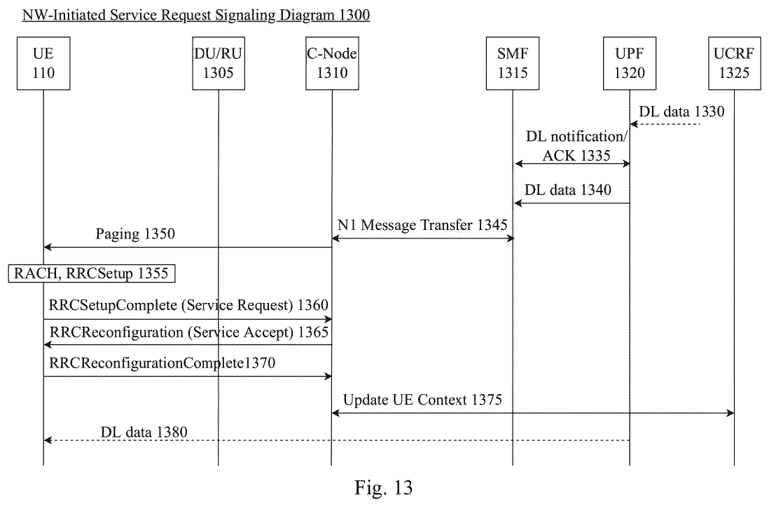

FIG. 13 shows an exemplary network initiated service request signaling diagram 1300 according to various exemplary embodiments. The signaling will occur between the UE 110, the DU/RU 1305 of the gNB 120A, the C-Node 1310, the SMF 1315, the UPF 1320 and the UCRF 1325.

In 1330, the UPF 1320 receives DL data for the UE 110. In 1335, the UPF 1320 informs the SMF 1315 of the DL data and receives an ACK from the SMF 1315. The UPF 1320 then, in 1340, sends the DL data to the SMF 1315. In 1345, the C-Node 1310 and the SMF 135 perform an N1 message transfer procedure. The C-Node 1310, in 1350, pages the UE 110. In 1355, the UE 110 performs a Random Access Channel (RACH) procedure and/or an RRC setup procedure to prepare to receive the DL data.

In 1360, the UE 110 sends an RRC connection complete message to the C-Node 1310 for the service request. In 1365, the C-Node 1310 sends an RRC reconfiguration message to the UE 110 indicating the service is accepted. The UE 110 then, in 1370, sends an RRC reconfiguration complete message indicating the RRC connection for the service request is complete.

In 1375, the C-Node 1310 and the UCRF 1325 perform a procedure to update the UE context based on the NW initiated service context. In 1380, the UPF 1320 may deliver the DL data to the UE 110.

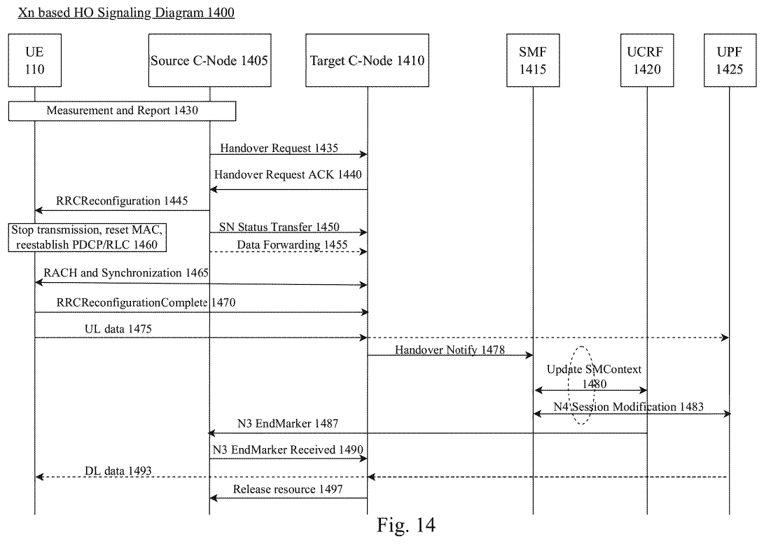

FIG. 14 shows an exemplary Xn based handover (HO) signaling diagram 1400 according to various exemplary embodiments. The signaling will occur between the UE 110, the source C-Node 1405, the target C-Node 1410, the SMF 1415, the UCRF 1420 and the UPF 1425.

In 1430, the UE 110 performs various measurements related to handovers and reports those measurements to the source C-Node 1405. In this case, it may be considered that the measurements indicate that a handover to the target C-Node 1410 should occur. In 1435, the source C-Node 1405 sends a handover request to the target C-Node 1410. In 1440, the target C-Node 1410 sends an ACK to the source C-Node 1405 acknowledging the handover request.

In 1445, the source C-Node 1405 sends an RRC reconfiguration message to the UE 110 to prepare the UE 110 for the handover. In 1450, the source C-Node 1405 sends an SN status transfer message to the target C-Node 1410 and in 1455 forwards any data that the source C-Node 1405 may have for the UE 110.

In 1460, the UE 110 stops any UL transmissions, resets the Medium Access Control (MAC) layer and reestablishes the Packet Data Convergence Protocol (PDCP) layer and/or the Radio Link Control (RLC) layer for the handover. In 1465, the UE performs a RACH and a synchronization procedure with the target C-Node 1410 and in 1470 indicates to the target C-Node 1410 that the RRC reconfiguration is complete. At this point 1475, the UE 110 may transmit UL data to the UPF 1425 via the target C-Node 1410.

In 1478, the target C-Node 1410 notifies the SMF 1415 of the handover. The SMF 1415 may then, in 1480, perform an SM context update with the UCRF 1420 to update the SM context at the UCRF 1420. In 1483, the SMF 1415 may also perform an N4 session modification procedure with the UPF 1425. As shown in FIG. 14, the operations 1480-1483 may run in parallel based on the JSON supported by http/2.

In 1487, the UPF 1425 may send an N3 end marker to the source C-Node 1405, which may then, in 1490 notify the target C-Node 1410 that the source C-Node 1405 has received the N3 end marker. The UPF 1425 may the send DL data via the target C-Node 1410 to the UE 110 in 1493. In 1497, the target C-Node 1410 may send a release resource message to the source C-Node 1405.

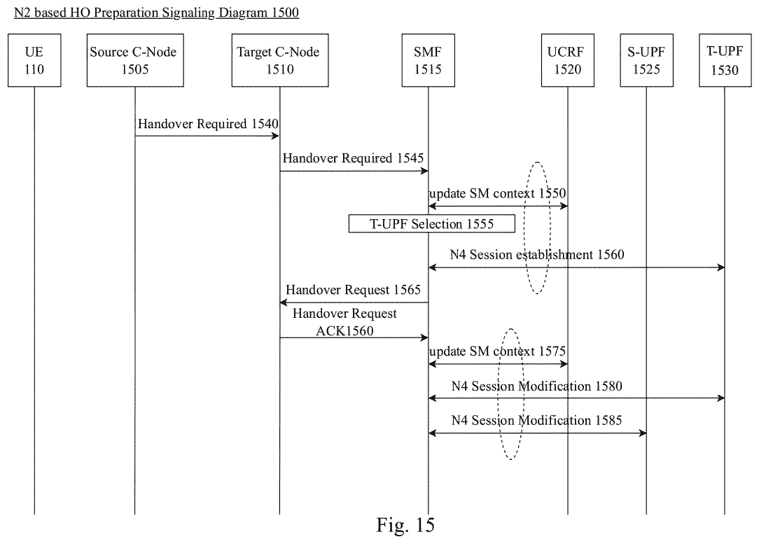

FIG. 15 shows an exemplary N2 based HO preparation signaling diagram 1500 according to various exemplary embodiments. The signaling will occur between the UE 110, the source C-Node 1505, the target C-Node 1510, the SMF 1515, the UCRF 1520, the source UPF 1425 and the target UPF 1530.

In 1540, the source C-Node 1505 sends a handover request to the target C-Node 1510. In 1545, the target C-Node 1510 notifies the SMF 1515 of the handover request. In 1550, the SMF 1515 and the UCRF 1520 perform an SM context update procedure to update the SM context of the UE 110 for the target C-Node 1510. In 1555, the SMF 1515 selects a target UPF for the handover. In 1560, the SMF 1515 performs an N4 session establishment procedure with the selected target UPF 1530. As shown in FIG. 15, the operations 1550 and 1560 may run in parallel based on the JSON supported by http/2.

In 1565, the SMF sends a handover request to the target C-Node 1510, which acknowledges the handover request in 1570. In 1575, the SMF 1515 and the UCRF 1520 perform an SM context update procedure to update the SM context of the UE 110 for the source C-Node 1505. In 1580, the SMF 1515 and the target UPF 1530 perform an N4 session modification procedure. In 1585, the SMF 1515 and the source UPF 1525 also perform an N4 session modification procedure to release the N4 connection. As shown in FIG. 15, the operations 1575-1585 may run in parallel based on the JSON supported by http/2.

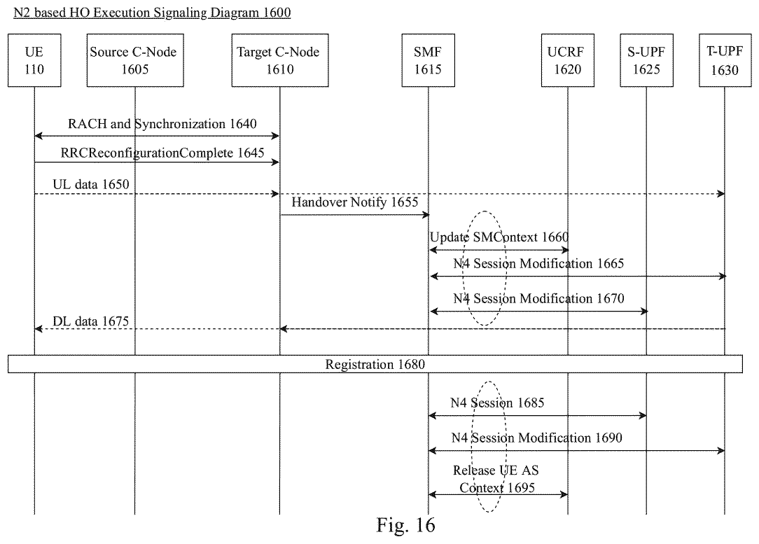

FIG. 16 shows an exemplary N2 based HO execution signaling diagram 1600 according to various exemplary embodiments. The signaling will occur between the UE 110, the source C-Node 1605, the target C-Node 1610, the SMF 1615, the UCRF 1620, the source UPF 1625 and the target UPF 1630. As described above, the handover preparation was performed using the signaling of FIG. 15.

In 1640, the UE 110 performs a RACH and a synchronization procedure with the target C-Node 1610 and in 1645 indicates to the target C-Node 1410 that the RRC reconfiguration is complete. At this point 1650, the UE 110 may transmit UL data to the target UPF 1630 via the target C-Node 1610.

In 1655, the target C-Node 1610 notifies the SMF 1615 of the handover. The SMF 1615 may then, in 1660, perform an SM context update with the UCRF 1620 to update the SM context at the UCRF 1620. In 1665, the SMF 1415 may also perform an N4 session modification procedure with the target UPF 1430. In 1670, the SMF 1615 and the source UPF 1625 also perform an N4 session modification procedure. As shown in FIG. 16, the operations 1660-1670 may run in parallel based on the JSON supported by http/2. In 1675, the target UPF 1630 may send DL data to the UE 110.

In 1680, the UE 110 may perform a registration procedure. As those skilled in the art will understand, the UE 110 performs a registration procedure after handover because the timing advance (TA) has changed. In 1685, the SMF 1615 and the source UPF 1625 may perform an N4 session release procedure. In 1690, the SMF 1415 may perform an N4 session modification procedure with the target UPF 1430. The SMF 1615 may then, in 1695, perform release the UE AS context procedure with the UCRF 1620. As shown in FIG. 16, the operations 1685-1695 may run in parallel based on the JSON supported by http/2.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A network function of a core network configured to:
store a plurality of contexts for a user equipment (UE); and
perform an operation with another network function associated with a procedure related to the UE being performed by the core network, wherein the operation is related to at least one of the plurality of contexts.

2. The network function of claim 1, wherein the plurality of contexts for the UE comprise two or more of an access stratum (AS), registration management (RM) context or a session management (SM) context.

3. The network function of claim 1, wherein the network function resides in a service based architecture (SBA) of the core network.

4. The network function of claim 1, wherein the network function resides in a radio access network (RAN).

5. The network function of claim 1, wherein the another network function is a C-Node function that performs functions related to a control plane of a base station of a radio access network and access and mobility management of the UE.

6. The network function of claim 1, wherein the another network function is a central unit control plane (CU-CP) of a base station of a radio access network, wherein the CU-CP resides in a service based architecture (SBA) of the core network.

7. The network function of claim 1, wherein the another network function is an access and mobility function (AMF) of the core network.

8. The network function of claim 1, wherein the procedure is a registration procedure and the at least one of the plurality of contexts is a registration management (RM) context.

9. The network function of claim 1, wherein the procedure is a deregistration procedure initiated by the UE and the at least one of the plurality of contexts is a session management (SM) context.

10. (canceled)

11. The network function of claim 1, wherein the procedure is a UE capability exchange and the at least one of the plurality of contexts is capability information for the UE.

12. The network function of claim 1, wherein the procedure is a protocol data unit (PDU) establishment procedure and the at least one of the plurality of contexts is a session management (SM) context.

13. The network function of claim 1, wherein the procedure is a protocol data unit (PDU) release procedure and the at least one of the plurality of contexts is a session management (SM) context.

14. The network function of claim 1, wherein the procedure is a UE-initiated service request procedure and the at least one of the plurality of contexts is a session management (SM) context.

15. The network function of claim 1, wherein the procedure is a network initiated service request procedure and the at least one of the plurality of contexts is a session management (SM) context.

16. The network function of claim 1, wherein the procedure is an Xn based handover procedure and the at least one of the plurality of contexts is a session management (SM) context.

17. The network function of claim 1, wherein the procedure is an N2 based handover preparation procedure and the at least one of the plurality of contexts is a session management (SM) context.

18. The network function of claim 1, wherein the procedure is an N2 based handover execution procedure and the at least one of the plurality of contexts is a session management (SM) context.

19. A network function residing in a service based architecture (SBA) of a core network and configured to:
perform functions related to a central unit control plane of a base station of a radio access network; and
perform functions related to access and mobility management of a user equipment (UE).

20. The network function of claim 19, wherein the functions related to the central unit control plane comprise a merged access stratum (AS) and non-access stratum (NAS) security control function, a registration function or a merged AS and NAS connection management function.

21. The network function of claim 19, wherein the functions related to access and mobility management comprise a merged AS and NAS mobility management function, a mobility anchor function, an access authentication and authorization function, non-3GPP access networks functions, or radio resource control (RRC) and configuration.

22-24. (canceled)
